(19) United States
(12) Patent Application Publication
(10) Pub. No.: US 2005/0183021 A1
(43) Pub. Date: Aug. 18, 2005

(54) Method for electronically packaging a user's personal computing environment on a computer or device, and mobilizing it for transfer over a network

(76) Inventors: Joel E. Allen, Rydal, PA (US); Samir Patel, Monroe Township, NJ (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/056,738

(22) Filed: Feb. 11, 2005

Related U.S. Application Data
(60) Provisional application No. 60/544,876, filed on Feb. 13, 2004.

(51) Int. Cl. G06F 3/00

(52) U.S. Cl. 715/747; 715/745; 715/741

(57) ABSTRACT

A computer system using open source software and operating systems is enabled over a global computer network to provide universal, selected applications. The applications can be accessed from a local personal computer, personal digital assistant (PDA), remote dedicated computer terminal, or like devices. Selected applications may include word processing, calendar, address book, picture viewing, music playing, games, email, Internet access, and the like. Personal data, such as pictures, music, games, “favorite places”, email addresses, and application settings are saved to the local client device and to a centralized customer support server. An included software manager ensures that the most current version of each application is used, and, if not available on the client, it can be uploaded, if necessary.

### CROSS REFERENCE TO RELATED APPLICATION

This application is based upon and claims benefit of co-pending U.S. Provisional Patent Application Ser. No. 60/544,876 entitled “Computer Network Applications Using Remote Client Platforms”, filed with the U.S. Patent and Trademark Office on Feb. 13, 2004 by the inventors herein, the specification of which is incorporated herein by reference.

### BACKGROUND OF THE INVENTION

1. Field of the Invention

This invention generally relates to a system and method for providing local and remote access to personalized computer applications and personal data and, more particularly, to consolidating a user's personal computing environment into a mobile package, and allowing it to be securely mirrored to a remote service center.

2. Background of the Art

In general, there are three things that make up a computer user's personal computing environment. These three being:
1. Personal Data
2. Application Settings
3. Software.

For example, in a word processing application, a user may enter preferences for default, font style and size, as well as margin size and spelling checking settings. In an Internet browsing application, the user may save one or more “favorite places” and a preferred “home” page. Furthermore, the user may save specific data concerning contacts, music, pictures, etc. Such personal settings and data are usually stored locally in the user's computer. However, when that same user uses a different computer or device, those personal settings and data are not available.

Additionally, the computer user may purchase and install on their computer specific preferred software applications, such as word processing applications, internet browsers, email, accounting applications, and other software tools. Those software applications, along with their associated settings and data are “local” to that computer. Once the computer user moves to another computer or device, that information has limited ability to “follow” that user. There are existing methods for transferring data, and also some extremely limited methods for transferring personalized software applications, mostly through web-based services. However, there are no systems currently available that consolidate the user's entire computing environment (data, applications settings, and software) and mobilize it for transfer over a network. The present invention allows for the user's entire personal computing environment to “follow” them to any computer or device.

One of the issues contributing to the inability to use various computers with the same data and applications arises from the nature of the operating systems and standards used in the Personal Computer (PC) industry. While there is a standard in the PC industry, it is a proprietary standard mostly owned by Microsoft® Corporation. Any time a user wishes to access data that resides within or has been created by a Microsoft® application, that user must own, that is previously have purchased, the relevant Microsoft® application. In addition, that Microsoft® application usually resides on a computer that has a Microsoft® operating system (OS).

The Windows Registry is a database that contains almost all Windows settings. Many applications use the Registry to store settings. On the Windows 2000 and Windows XP operating systems, a user's personalized application settings and preferences are also stored in the Registry. Storing information in the Registry makes it easy for Windows applications to access personalized settings. However, moving settings stored in the Registry from one computer to another is very cumbersome and impractical. It is often impossible to backup and/or migrate application settings without the use of extensive programming.

There are two kinds of stand-alone software: the first being proprietary and the second being open-source or free software. Proprietary applications cost money and are protected by their owners against transfer and copying. Furthermore, as new versions of the proprietary applications are created, the user must spend more money to keep his or her computer up-to-date with the latest version.

The open (free) software movement, with products like Linux, Ximian Evolution, MySQL, etc. has grown considerably, and has created software applications that are equal to or better than their counterparts. The one obvious difference is that they are “open”, and can be freely distributed and updated.

A goal of the present invention is to offer clients the freedom and flexibility of a personal computing environment that is available anywhere, on any device.

### SUMMARY OF THE INVENTION

The present invention enables the user's personal data files to appear to follow them to any computer or network device, based on an authenticated login. That authenticated login prompts the system to gather the user's personal data files, looking first to the local client for the relevant data. If, however, the user is on a new or different computer or device, that authentication prompts a file sharing system to upload all relevant data to the client, based on certain cache rules that have been pre-selected by the user/subscriber. The present invention also activates that same local caching protocol for software applications upon login. The local system (client), in conjunction with the remote service, determines what software applications the user has activated and requires. In a situation when the user's required software application is not available on the local client, the system retrieves the required application from the remote service automatically, caching it on the local client for further use by that user/subscriber. These software applications can include open-source applications that can be freely distributed and updated, and can also include proprietary software. In the system described herein, all user data is stored in encrypted volumes. A two-step process is required to use this data. First, the user client must obtain an authentication token in order to gain access to their encrypted data. Second, the user client must decrypt the data. In order for these processes to proceed, valid Authentication Information must be provided. Authentication Information is information sufficient to uniquely identify a user. It may start out as a name, password, and PIN number, but may evolve into something more secure.

In addition, a graphic interface module offers Data Migration from the client to the underlying System. The system provides users with a simple interface that allows them to consolidate the local client's personal data and personal applications settings. This may be done in several ways. First, by way of File Explorer, the system will show a remote file tree that displays files stored by the service. This file tree will contain standard file categories for different types of files (music files, pictures, etc.). This file tree will also show the user a tree view of the files stored on their local PC's. The user will be able to copy files into the service through standard “drag and drop” and “cut, copy, paste” procedures. The user may also migrate or consolidate personal data and applications settings from the local client to the system using a migration wizard. This wizard would prompt users to assign personal data and applications to pre-determined locations in the remote mirrored drive.

The system of the present invention provides users witi certain default software applications and software installation options. Those default applications are shown on the face of the graphic user interface and represent commonly used software tools including Personal Information Manager, Web browser, My Music, My Files, My Photos, and more. Once the user has logged into and been authenticated by the system, additional software options will be available. Those options include adding additional free software, adding premium software applications that could be distributed by outside third party software vendors, and also private Windows® based software through the use of a Windows® software installer module.

It is therefore, an object of the present invention to consolidate the user's personal data and application settings using the local graphics interface, and simultaneously mirror that entire computing environment to a remote service center over a wide area network, that avoids the disadvantages of the prior art.

Another object of the present invention is to maintain computer applications current using automatic updating. A remote software manager monitors software and confirms, updates, and patches those applications as needed by the user. Every time a user moves from one machine to another, the same software, including all personal settings and data is maintained. Since the user need not purchase multiple copies of the software, there is no cost to the user to move from one computer terminal to another. A related object is to store a user's personal data and applications both locally and at a remote centralized customer service center.

Another object of the present invention is to enable sharing of personalized data and certain applications with select subscribers upon authorization by the owner. A related object is to enable remote control access of a client's applications and data over a secure network.

In addition, the present invention enables owners and developers of proprietary and/or freely available software applications to distribute their applications through a secure system using a mobilized interface. This will allow for a mobile software applications system, allowing owners of that software to securely archive and transfer those applications to other computers or network devices. This system will also enable software developers and companies to easily convert their business model from a one-time sale to a service based model, and also offer secure client authentication and billing features. Another object of the invention is to enable user's to install private software into a secure mobilized interface for backup and remote access functionality. The present invention enables a mobilized computing environment by incorporating several “pillars” of existing technology using a unique integrated system. Those underlying pillars include a graphics system, a messaging system, and a distributed file sharing system. The present invention focuses on the unique integration of those existing pillars, with a simple to use mobile graphics system. That graphic system can be embodied as a Windows application, or a Graphic User Interface (GUI) on a non-Windows terminal, computer, or network device.

The Distributed File Sharing System described herein is the primary “pillar” of the system, and, as such, the present invention integrates the Distributed File Sharing System with several unique hooks. Those hooks fall into four categories; Data Layout, Hoarding, Conflict Resolution, and Administrative tools.

Through Data Layout, different types of data (application data, user data, and temporary data) are treated differently. Through Hoarding, the invention automatically maintains current versions of applications, and latest versions of the user data to the user on any authorized terminal or network device. Through Conflict Resolution, the system enables disconnected functionality while preventing conflicts from occurring in the application data or the user's data. Through Administrative Tools, the invention enables applications, including the Slide™ and third party applications, to utilize the above functionality.

According to a first embodiment of the present invention, an application called a Siide™ can be downloaded onto any Windows® PC. Once the Slide™ application is installed on a local client, an authentication module is enabled that allows the user to login to, or create a remote service account.

Once logged in, the user may begin consolidating files and applications to the Slide™. A user may choose from any or all data files, including proprietary and non-proprietary (open) files, to consolidate. Those files may include Microsoft Word files, Open Office Files, MS Excel files, image files, music files, etc. There is no restriction on the type of file, nor the size that can be attached. Once the data files have been assigned to the Slide™, the user may then choose to assign specific applications to the system. The Slide™ has several “Application” buttons on its face, each corresponding to a default application. Such default applications may be open source (free), and can therefore be transferred and updated without license, penalty, or fee. Proprietary applications may be installed into the Slide™ and premium applications will be available from a Software tab on the Slide™.

A user's account will mirror the user's local data, software settings, and software applications. All data files and application files are local and remote simultaneously. Once the user's personal data and application information is consolidated and mirrored, it can be securely accessed from any PC or network device that has a Slide™ installed, or from any other PC or network device that connects to a central service. Those PC's or Network Devices could have different operating systems, pre-loaded software, and marginal or sporadic network connectivity.

According to another embodiment of the invention, a user can access their personal computing environment through a smart terminal. Such smart terminals resemble a standard desktop computer and are made up of similar hardware components. However, in addition to the normal components contained in a personal computer, the smart terminal includes a touch-screen monitor and a biometric scanner in order to facilitate the user in quickly logging in to the system based on a physical identity. Such smart terminals will have an open-source operating system, a distributed file system, and open-source applications, integrated with a graphic user interface according to the present invention, and are connected to the Internet through a broadband network connection. A user begins the authentication process by pressing their thumb or finger onto the biometric scanner. Once the system recognizes their fingerprint identity, they are prompted to enter a PIN number as an additional security measure. Once the PIN number has been entered and authenticated, the user's personal computing environment is displayed on the terminal. The applications and data shown on that smart terminal are stored locally on the client, and instantaneously mirrored to a remote service center for easy access from any other authorized smart terminal or application.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a high-level block diagram of an embodiment of the system of the invention;

FIG. 2 is an illustration of system components according to the present invention;

FIG. 3 is an overview illustration of conflict resolution integration;

FIG. 4 is a diagram showing Data Layout functionality as it relates to Application Data;

FIG. 5 is a diagram showing Data Layout functionality as it relates to User Data;

FIG. 6 is a diagram showing Data Layout functionality as it relates to Temporary Data;

FIG. 7 is an overview diagram showing how the invention manages Hoarding;

FIG. 8 is an illustration of a system according to a first embodiment of the present invention for describing additional features;

FIG. 9 is an overview of Authentication/Encryption functionality;

FIG. 10 is an illustration of a Slide™, a Windows based application that can be downloaded onto a personal computer, according to a first embodiment of the present invention;

FIG. 11 is an illustration of an Authentication Login module according to a first embodiment of the present invention;

FIG. 12 is an illustration of an Administration module portion and Software module portion of the Slide according to a first embodiment of the present invention;

FIG. 13 is an illustration of a personal computer desktop according to another embodiment of the present invention;

FIG. 14 is a high-level illustration of the components of a smart terminal;

FIG. 15 is an illustration of a personal digital assistant GUI configured according to a further embodiment of the present invention; and

FIG. 16 illustrates a network of devices using distributed services according to the present invention.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

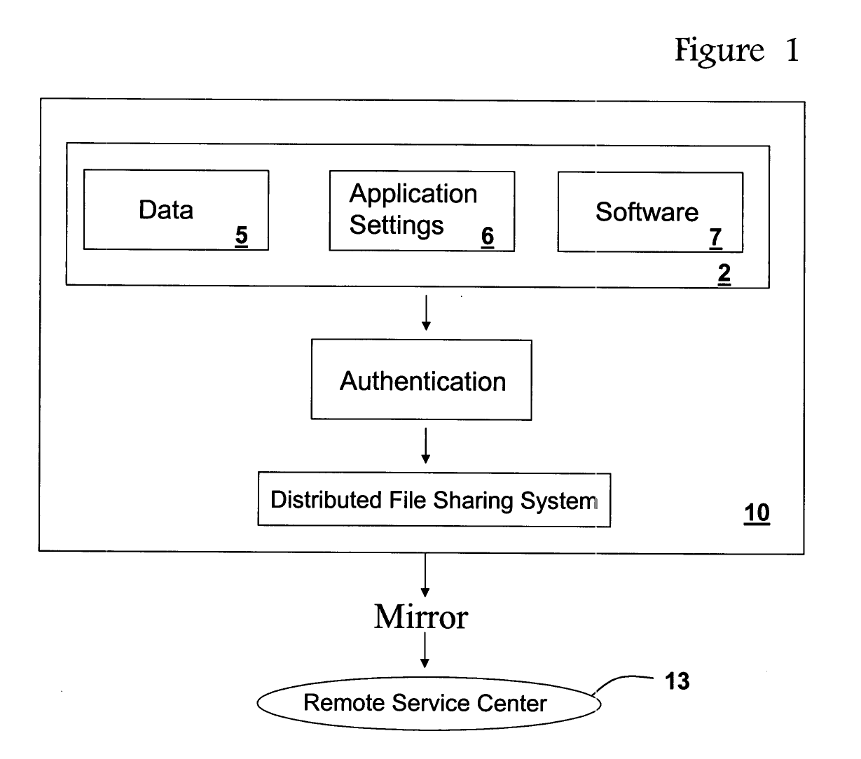

Referring to FIG. 1, a user's personal computing environment 2 comprises data 5, application settings 6, and software 7. The present invention enables a system for packaging the user's entire computing environment 2 and mirroring it for transfer over a network. The computer environment 2 is stored on a local client 10 and simultaneously mirrored by secure network to a remote service center 13.

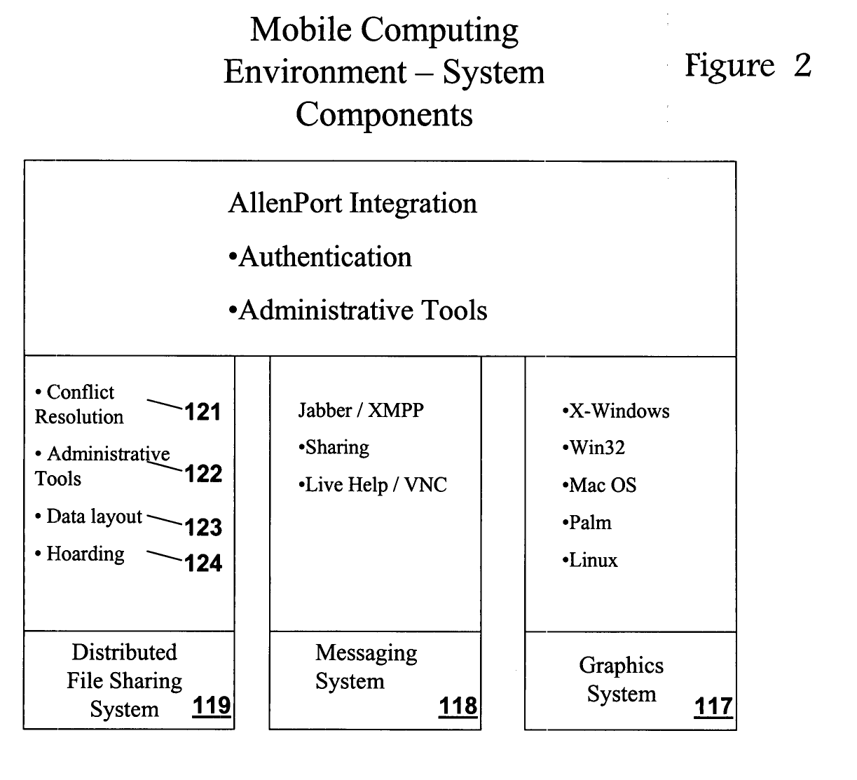

The system components for a mobile computing environment of the present invention are illustrated in FIG. 2. Several “pillars” are incorporated into the system using a unique integrated system. The pillars include a graphics system 117, a messaging system 118, and a distributed file sharing system 119.

The present invention focuses on the unique integration of such “pillars” with a graphics system 117. The graphic system 117 can be embodied as a Windows application, or as a Graphic User Interface (GUI) on a non-Windows terminal, computer, or network. The graphic system “pillar” 117 provides an interface between the user and selected software and data for purposes of authentication and execution of applications.

The messaging system 118 enables a subscribed user to communicate with other users and to selectively share data and files. Such communication may be for the purpose of instant messaging, application sharing, live help, and video conferencing. File sharing may include sharing documents, pictures, music, and the like.

The distributed file sharing system 119 described herein is the primary “pillar” of the system, and, as such, the present invention integrates the distributed file sharing system with several unique hooks. Those hooks fall into forum categories; Conflict Resolution 121, Administrative Tools 122, Data Layout 123, and Hoarding 124.

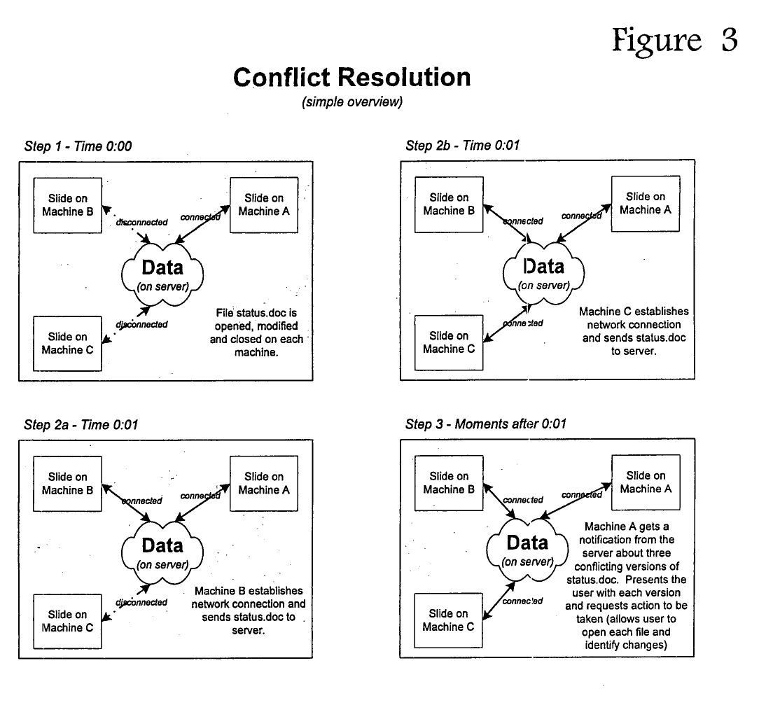

Through Conflict Resolution 121, the system enables disconnected functionality while preventing conflicts from occurring in the application data or the user's data. Through Administrative Tools 122, the invention enables applications, including the Slide™ and third-party applications, to utilize the above functionality. Through Data Layout 123, different types of data (application data, user data, and temporary data) are treated differently. Through Hoarding 124, the invention automatically maintains current versions of applications, and makes available the latest versions of the user data to the user, on any authorized terminal or network device. FIGS. 3-7 illustrate the functionality of the primary hooks used in connecting a client terminal to the system.

1. Application Specific Conflict Resolution.
a. Specific rules are defined for the cache manager to handle conflicts in User Data. For example, if a user is disconnected from the system and updates data in an address book application and then, later, modifies the same data from a separate disconnected terminal, embedded rules present a hierarchy for resolving the differences between such data, when the terminals are reconnected.
b. In FIG. 3, and example of Conflict Resolution is illustrated.
   i. In Step 1, the same document is opened and modified on three different terminals, only one of which is connected to the remote server.
   ii. In Step 2a, a second terminal establishes a network connection and automatically sends the modified document to the remote server.
   iii. In Step 2b, the third terminal also establishes a network connection and automatically sends the modified document to the remote server.
   iv. In Step 3, the first terminal is notified that conflicting versions of the document are present and enables the user to review and identify changes in order to determine the file to maintain.
c. Other Conflict Resolution scenarios can be handled by embedded rules that present a hierarchy for resolving the differences between conflicting data files.

2. Administrative Tools.
a. Administrative tool utilities allow creation and maintenance of Application, User, and Temporary Data. This may also include third party/unique applications.

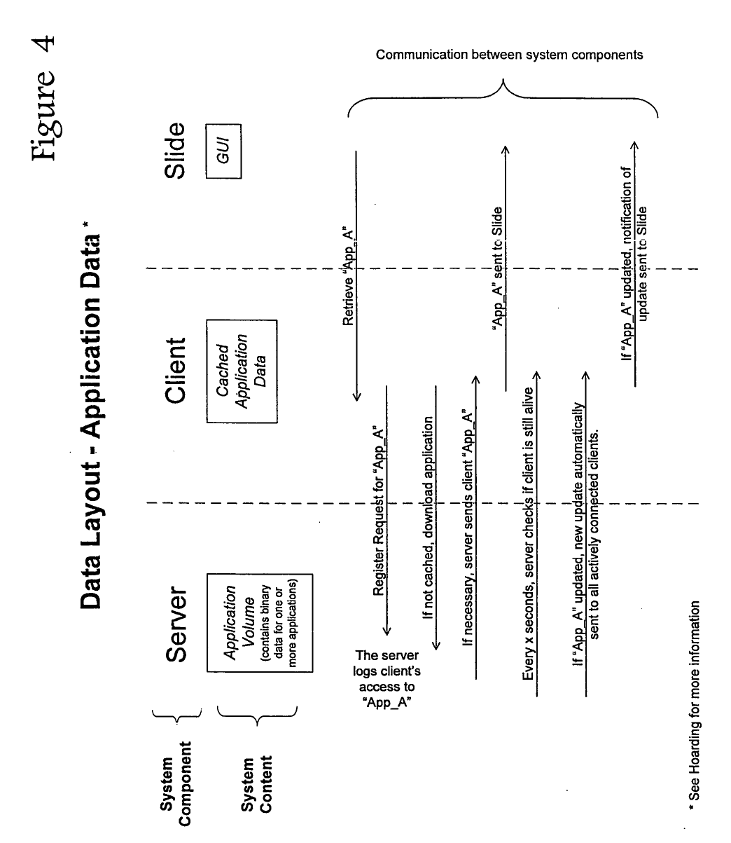

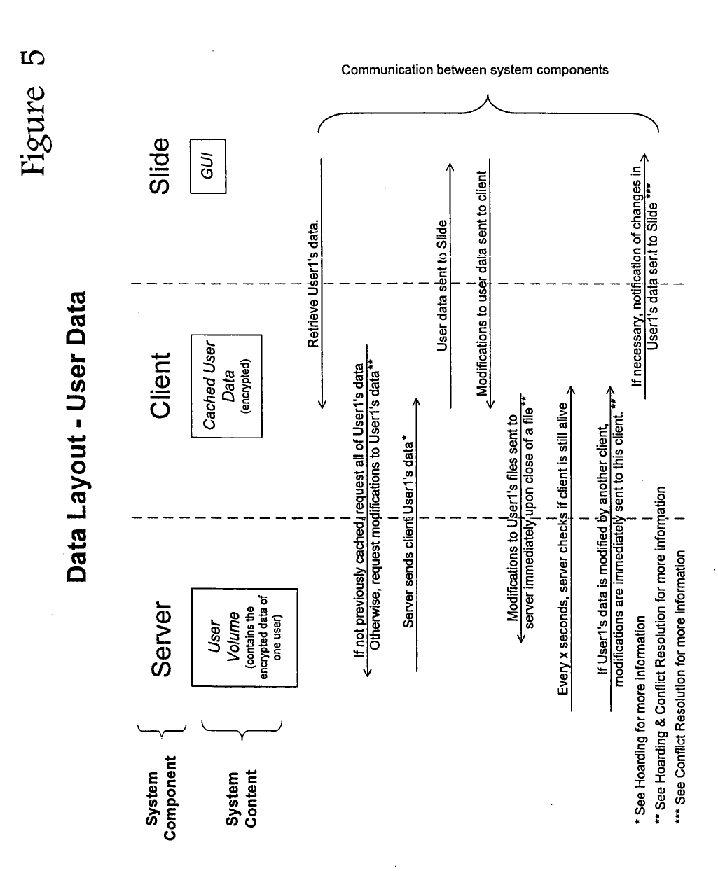

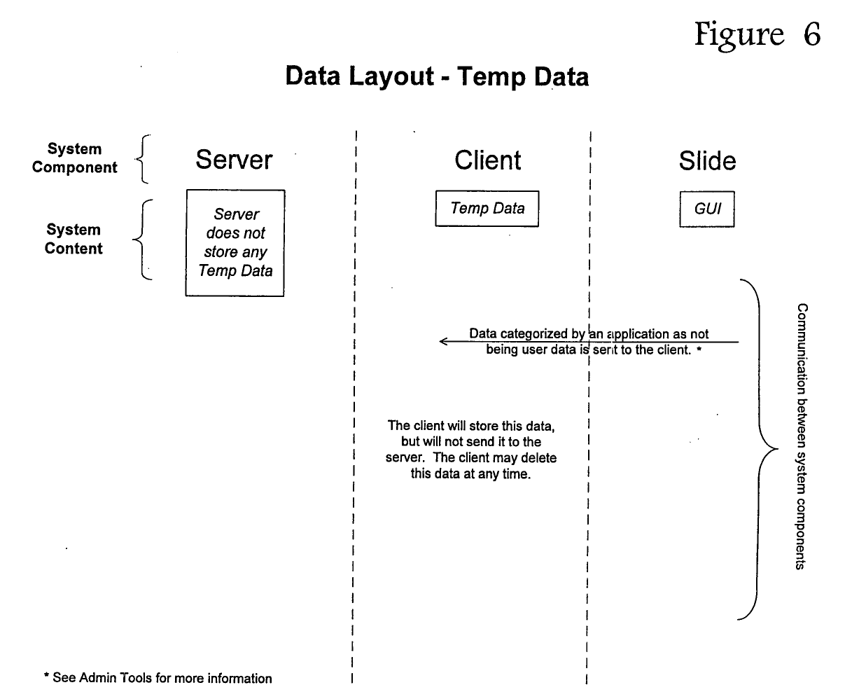

3. Data Layout. The system contains three different types of data:
a. Application Data—System files and end user applications. This data is made available to all users. Different versions of Application Data are maintained and organized in a defined volume structure. FIG. 4 illustrates the flow of communication between the user interface, the client terminal, and the remote server.
   i. Initially the user indicates a desire to execute a selected application, “App A” by indicating such on the GUI.
   ii. The GUI sends a signal to the client to retrieve “App_A”.
   iii. The client registers the request for “App_A” with the remote server to verify appropriate permission and authentication.
   iv. If “App_A” is not cached on the client, the client downloads the application from the remote server.
   v. As soon as the application is available on the client, it is sent to the GUI.
   vi. While “App_A” is registered with the remote server, the server periodically verifies that the client is still actively connected.
   vii. If a new version or update of “App_A” becomes available, the server automatically sends the new version to actively connected clients.
   viii. If the client receives an update, it may notify the user via the GUI of the available update.
b. User Data—Information that distinctly belongs to a user. Each user's data is stored in distinct encrypted volumes that only the user is able to access. FIG. 5 illustrates the flow of communication between the user interface, the client terminal, and the remote server.
   i. Initially the user indicates a desire to retrieve data by indicating such on the GUI.
   ii. The GUI sends a signal to the client to retrieve User1's data.
   iii. If not previously cached, the client requests all of User1's data from the remote server.
   iv. The remote server sends User1's data to the client.
   v. The client sends User1's data to the GUI.
   vi. If the user modifies the data, it is sent to the client.
   vii. The client automatically sends the User1 data to the remote server immediately upon closing the file.
   viii. The server periodically verifies that the client is still actively connected
   ix. If User1's data is modified by another client, the server automatically sends the modification to the original client.
   x. If the client receives a modification notification, it may notify the user via the GUI of the changes.
c. Temporary Data—Anything that cannot be categorized as Application or User Data. FIG. 6 illustrates the flow of communication between the user interface, the client terminal, and the remote server.
   i. Data that is categorized by an application as not being user data is sent to the client, which will store the data locally, but will not send it to the remote server. An example of this temporary data would be an application or part of an application, which has been cashed on the client for performance reasons.
   ii. The client can delete temporary data at any time.

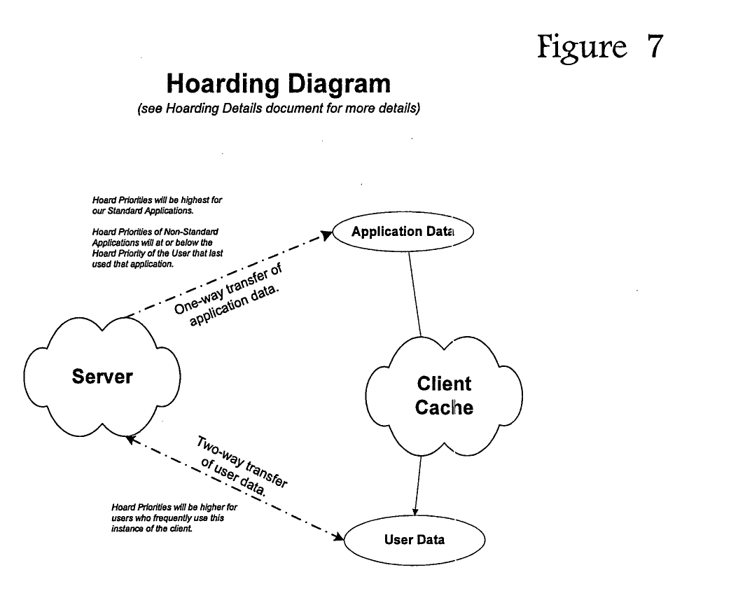

4. Hoarding.
a. In FIG. 7, an example of Hoarding Priorities is illustrated.
b. Hoarding enables an interface with the cache manager that will ensure User and Application Data is properly synchronized on client terminals, whether a local or remote client terminal. In this way, a client's terminal Application Data is always kept up-to-date as long as a network connection is present. The user need not be logged into the system for an automatic propagation feature to keep all files current. User data will be stored and hoarded on terminals designated as “trusted” terminals.
c. Hoarding is the process through which the Slide maintains the most up-to-date copy of Applications and User Data. A process will run on each installed instance of the Slide that will Hoard (download into the cache) various types of data. If space is not available to Hoard all data, data with low Hoard Priorities will not be Hoarded. Data will be Hoarded according to the following rules:
   i. Application Data
      By default, the Standard Applications (Web Browser, OpenOffice.org, Music Player, etc. . . . ) provided by the Slide will automatically be Hoarded. Hoarding of these applications will proceed immediately upon the launch of Slide. A user does not need to be authenticated for this process to occur. Hoarding of Standard Applications has the highest Hoard Priority. Non-Standard Applications (third party and Premium Applications) will only be Hoarded if that Non-Standard Application has been used by a User of the Slide. The Hoard Priority of Non-Standard Applications will be the same or less than the Hoard Priority of the user that has last used that application.
   ii. User Data
      The Slide will keep a history of users that have authenticated into the system. As space is available, each user's Data Files will be hoarded by the Slide. The highest Hoard Priority will be assigned to users that use the Slide most frequently. Slide will set the Hoard Priority of an Actively Authenticated User to the highest Hoard Priority (same Hoard Priority as Standard Applications). The Hoard Priority of other users will be lower, with the lowest Hoard Priority assigned to the users that have used the Slide least frequently. Furthermore, Data Files will typically be associated with specific applications (for example, a Music File will be associated with the Music Player, a Text Document will be associated with OpenOffice.org, etc. . . . ). Within a user's Data Files, the Hoard Priorities for specific types of files will vary based on the frequency of use of those types of files. Overall, Hoarding of User Data will primarily be based on User Activity

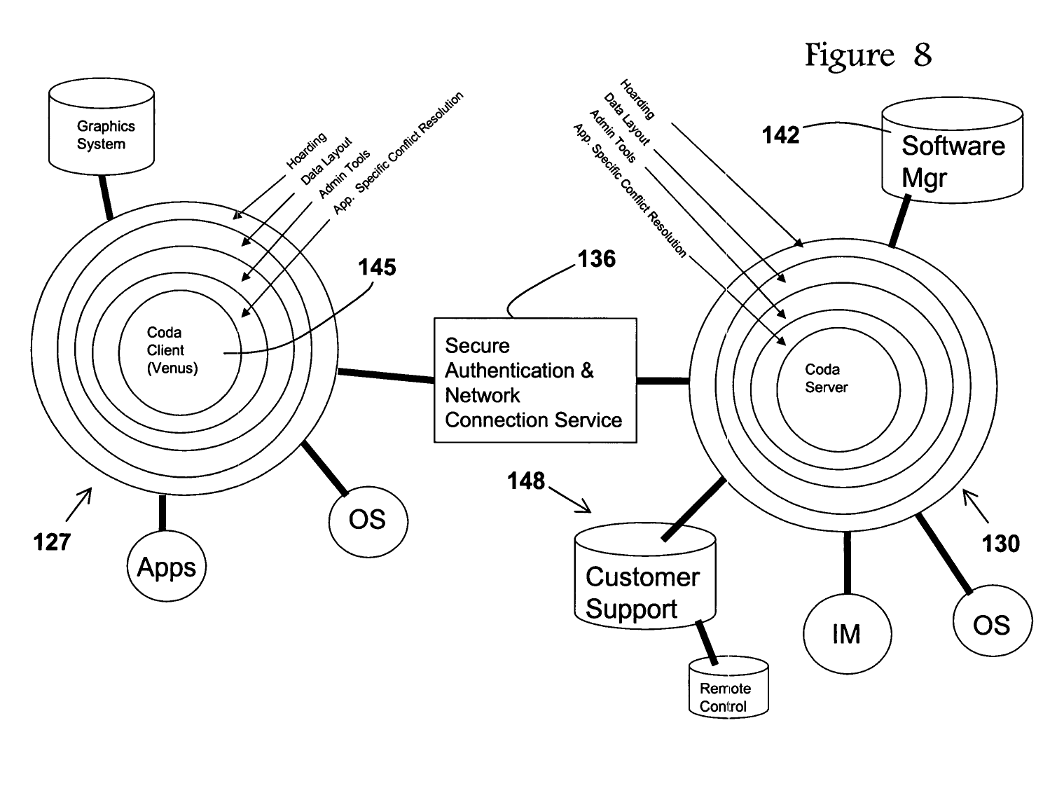

FIG. 8 shows a more detailed functional view of a client 127 connected to a system server 130. Implementing Hoarding functionality for Application Data, the software manager 142 ensures that the most current version of each software application is available for the user. As long as the terminal is connected to the system, whether the user is logged in or not, the software manager 142 automatically updates the software on the terminal. If a user is logged into a different client computer or PDA and attempts to open an application not stored on that local client, the software manager 142 instantly determines which application is needed, confirms all the updates are in place, and uploads that complete application, or any missing or damaged parts to the client 127. This maintains a consistent computing platform throughout the system. Such uploading is performed in the background without input from the user. The cache manager 145 together with Hoarding, Data Layout, Administrative Tools, and Conflict Resolution provides automatic propagation of applications and data without interrupting the user's application execution.

Furthermore, the system allows disconnected operation. That is, if a user is logged onto the system and the network connection 136 is severed, the user can continue to operate, since the applications are stored both locally and updated from a remote server 130. Once the network connection 136 is restored, personal data is transferred by the cache manager to the remote service center. In addition, the built-in conflict resolution function resolves any differences between the personal information that is temporarily stored on the disconnected client & the user data located on the remote service center.

Two additional features in the system enable snaring of data with other subscribed users and remote control functionality.

Assume a user who is logged onto the system would like to share what they are viewing on their screen, for example a picture, with another subscriber. The user simply presses a “Share” button located on the desktop. A predetermined and personalized “buddy” list is then displayed on desktop. Such “buddy” list is known in the art and is similar to a buddy list generally associated with any instant messenger program. The user would then select any identity from the “buddy” list, and, assuming that person is also currently logged into the system, that person would be instantly connected to the user, viewing everything just as the main user sees it.

The remote control functionality is even more powerful. Assume a subscriber needs help to create a spreadsheet or change the home page on their web browser. The user would simply press a Live Help button or the Share button on their desktop. If the user is requesting Live Help, they would be instantly connected to a customer support section 148 of the Remote Service Center 13 (FIG. 1). A customer service representative can assist the user using a simple text messenger box. However, if there is a need for further assistance, or the user just wants the customer representative to do it for them, the customer service representative can take remote control of the user's machine, and instantly have complete access to the client desktop. The user would see the mouse move, see the application manipulated, and the request fulfilled. If the user presses the Share button on the desktop, they would be prompted to choose from their active buddy list. Once they choose a buddy, that person would be given remote control capabilities over the client.

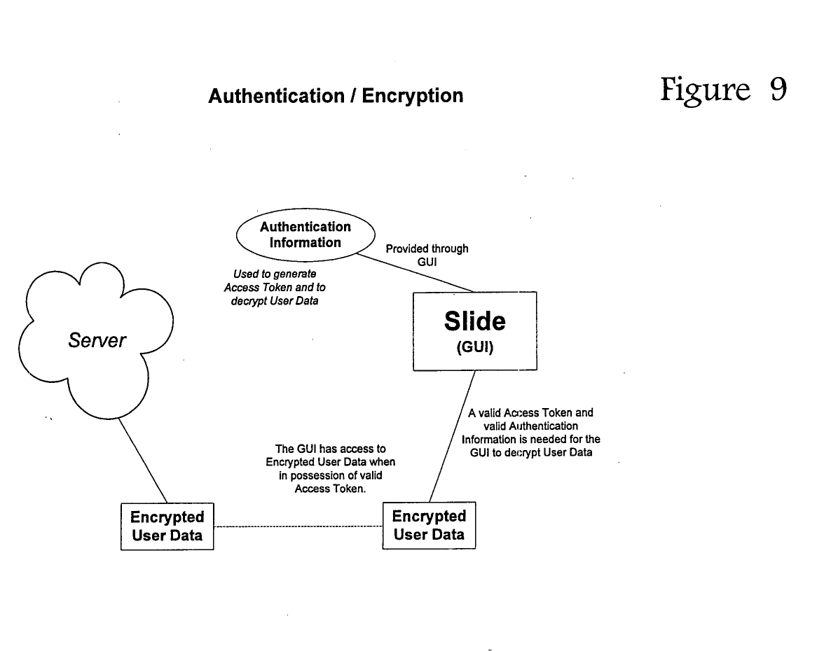

FIG. 9 illustrates the Authentication/Encryption process used by the present invention. All user data is stored in encrypted volumes. A two-step process is required to use this data. First, the user client must obtain an authentication token in order to gain access to their encrypted data. Second, the user client must decrypt the data. In order for these processes to proceed, valid Authentication Information must be provided. Authentication Information is information sufficient to uniquely identify a user. Authentication Information is first used to generate an Access Token. This Access Token is validated by the server and provides the client with access to the user's encrypted data. As long as the Access Token has not expired, the client will have access to the user's encrypted data. In order to decrypt and utilize User Data, the will utilize the Authentication Information to perform “on the fly” decryption/encryption. As files are created/modified/closed, the client will continuously decrypt/encrypt data as needed. This process will ensure that all data is always stored in encrypted form and that the data is only decrypted on access.

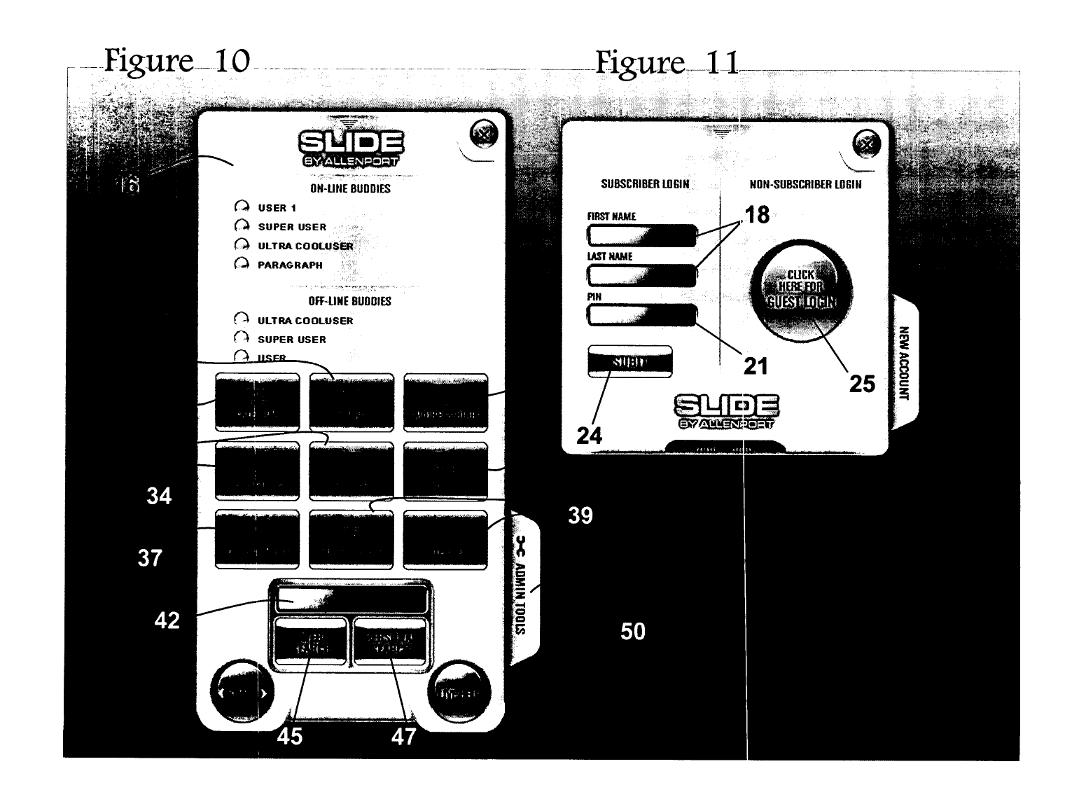

A first embodiment of the invention is shown in FIG. 10. The Slide™ 16 is a software application that can be downloaded to any PC. The Slide 16 enables a user interface between an operator and various applications that can be facilitated by such Slide 16. Once the Slide™ 16 application is installed on a local client, an authentication module, such as shown in FIG. 11, is enabled that allows the user to login to, or create a remote service account. User authentication for a service subscriber can be provided by requiring the user to enter first and last name 18 and a password or PIN 21. The user transmits the authentication by the submit button 24.

For a guest, non-subscriber, the system may allow a new user or guest to log in using a separate procedure, such as the guest login button 25.

In operation, once the PIN is entered, the Slide 16 enables the user to access a variety of applications needed and chosen for their personal computing requirements. In the illustrated example of FIG. 10, the applications represented by specific icons comprise calendar 31, email 32, contact list/address book 33, my pictures 34, my music 35, my TV 36, my documents 37, my shopping 38, and an Internet browser 39. The user may add or remove buttons, as desired.

From the primary Slide screen, a user can also initiate built-in search capability. The user enters a search stream in a window 42 and selects an appropriate button to either search on the Internet 45 or in personal documents and files 47.

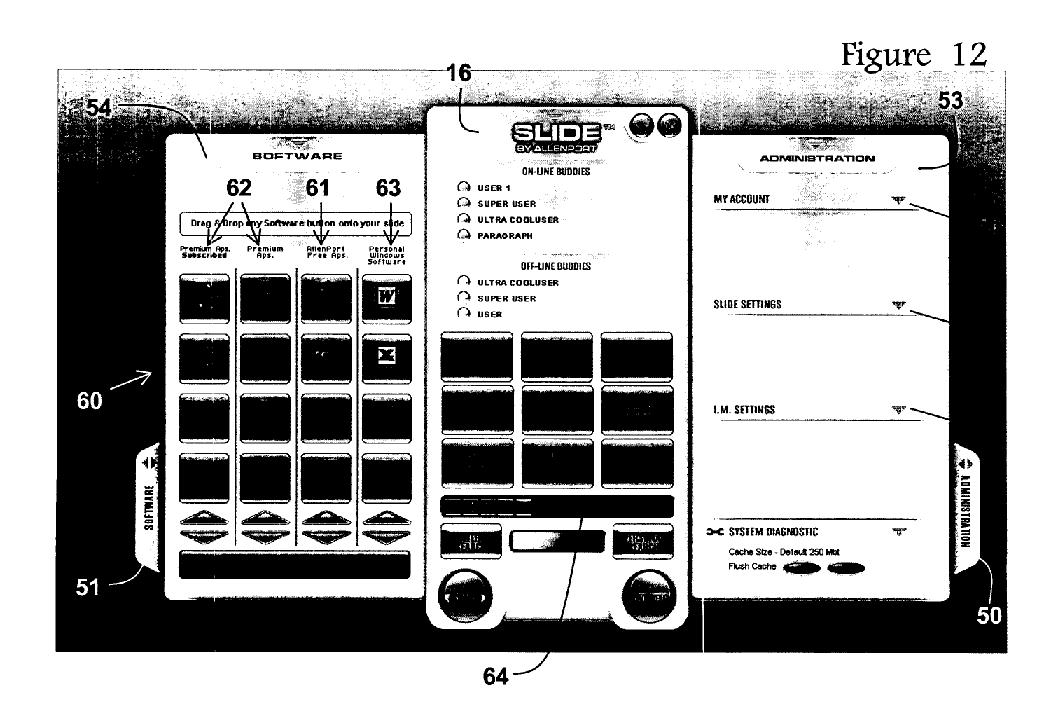

FIG. 12 shows the Administration portion 53 and Software portion 54 that can be accessed through the admin tools link 50 or software link 51, respectively. Such Administration portion 53 may include pull-down menus for managing account setup 56, Slide settings 57, and instant messaging (IM) settings 58. Once logged in, the user may begin consolidating data files and application settings to the Slide™ 16. A user may choose from any or all data files, including proprietary and non-proprietary (open) files, to consolidate. Those files types may include Microsoft Word files, Open Office Files, MS Excel files, image files, music files, etc. There is no restriction on the type of file, nor the size that can be attached. Once the data files have been assigned to the Slide™, the user then may choose to assign specific applications to the system. Third party and built-in software, such as proprietary games, databases, and drawing programs, may be launched by selecting the corresponding icon 60 under the Software link 51.

The system provides users with a certain number of Standard Applications and software installation options. The Standard Applications are show on the face of the graphic user interface and represent commonly used software tools including Personal Information Manager, Web browser, My Music, My Files, My Photos, and more. For proprietary and/or other Non-Standard Applications, the user can gain access through the Software Tab link 51. Once the user has logged into and been authenticated by the system, additional software options will be available. Those options include adding additional free software 61, adding premium software applications 62 that could be distributed by outside third party software vendors, and also installing private Windows® based software 63 through the use of a Windows® software installer module.

A quick launch task bar 64 provides easy access to selected software applications on the face of the Slide 16. The user may add or remove applications to the “Quick-Launch” section 64, as desired, by well-known drag and drop operation.

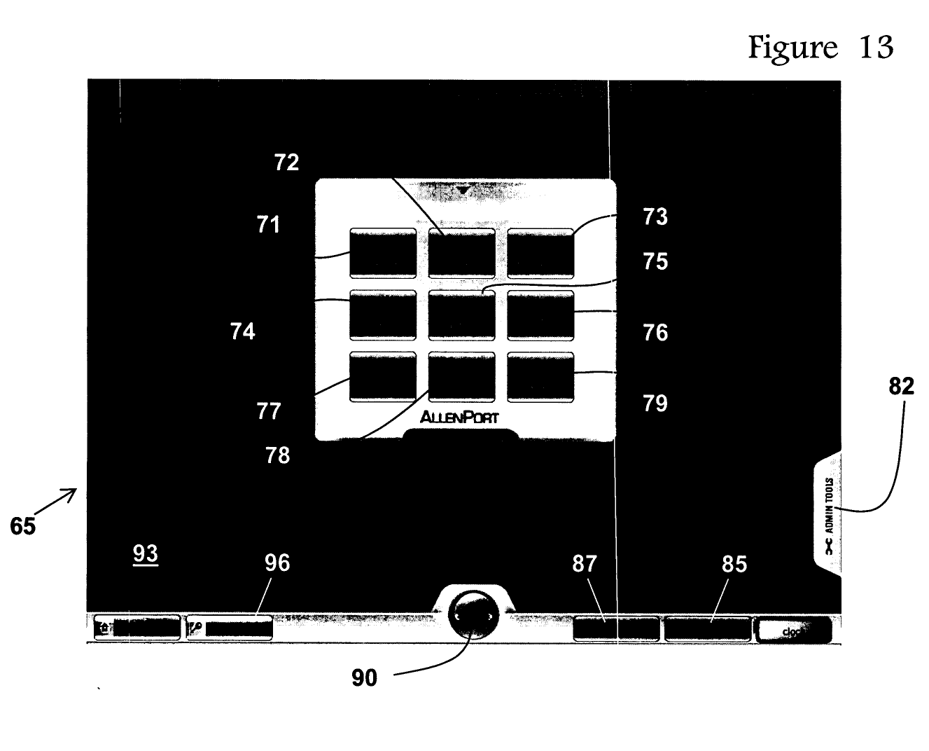

In another embodiment, the system is installed on a dedicated client terminal having a screen display, such as shown in FIG. 13. In this embodiment, such screen, indicated generally as 65 is touch sensitive. Initially, the screen displays a simple login screen. To begin the application, a user touches the screen and the system requests the user to verify his or her identity. In some embodiments, a biometric device, such as a fingerprint scan, may perform such verification. Once the user activates the verification device, a PIN number page is displayed. The user is then prompted to enter their personal identification number (PIN). Once the PIN is entered, the user views a personalized desktop, consisting of Standard Applications and/or chosen Non-Standard Applications for their personal computing requirements. In the example illustrated in FIG. 13, the applications represented by specific icons comprise calendar 71, note pad 72, contact list/address book 73, my music 75, my pictures 74, games 76, office tools 77, e-mail 78, and an Internet browser 79. The user may add or remove any applications as required. For proprietary and/or other Non-Standard Applications, the user can gain access through the admin tools link 82. Additional links, such as for instant messaging (IM) 85, live help 87, and sharing 90 will be provided, as well.

To begin execution of an application, the user simply touches the appropriate icon and the most recent version of the selected application software launches. The user is able to enter data in any of the applications, make changes to the settings, and carry out any operation they would be able to do on a standard PC. In another embodiment, all the provided software applications are available as open source products.

Continuously, while a user is logged onto the system, the user's personal information (data and application settings) is “saved” in two places. First, the information is “saved” in a data storage medium on the local machine itself for two reasons:
a) It provides instant access to the user's personal data the next time that same user desires access on that same computer.
b) That data also remains in the local device as a security feature. If the network is unavailable to transmit such data to a centralized computing service, the user can still have access to all their personal data and applications settings.
   Second, the personal information is saved remotely, to a Remote Service Center 13 (FIG. 1). This allows the user to access the system from another computer or network device. The user can login as described above, and have complete access to all that personal information, not just the personal data, but also the application settings that instruct the applications to operate as selected by the user. This offers three distinct advantages to the user:
1. Personal data and settings are available on any compatible computer or device.
2. Personal data and settings are safe, eliminating the need for backups, and eliminating the risk associated with such personal data and settings being chained to a local machine. For example, a problem with a local machine is much less severe, since the data is backed up remotely. If the local computer is stolen or damaged in any way, it is much easier to decide whether to repair or replace that machine.
3. The personal data is managed and given appropriate protection based on category.

For example, a user may decide that some personal data should be permanently archived, never to be deleted or modified in any way, such as personal photos and the like. Moreover, once select personal data is stored in such permanent archive, it would require a specific process and a conscious effort to delete the data.

In addition to personal data, another feature that “follows” the user to any computer or network device is the customized desktop 93. The desktop 93 comprises a simplified graphic providing access to only the specific applications that the user requires to complete their tasks. Desktop 93 can be modified as appropriate based on different screen resolutions.

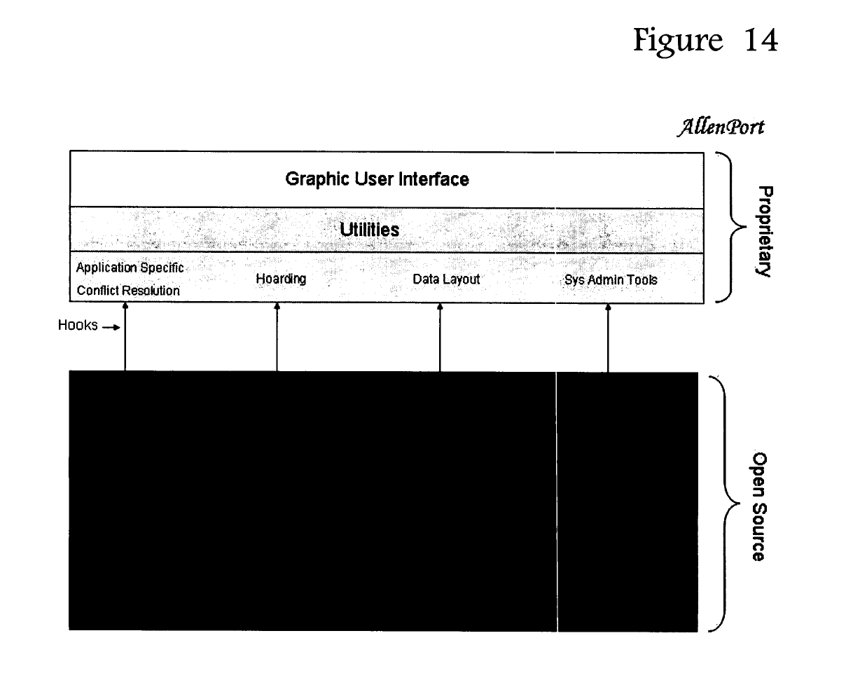

Referring now to FIG. 14, the system according to the present invention uses an open source Linux operating system 150, for which many open source applications 153 are available. One such application is a distributed file sharing system called Coda 156 that enables users to connect to a remote server, and acts as a manager for personal data, software applications 153, and software application settings. Coda 156 is an advanced networked distributed files system that has many features that are very desirable for network file systems, such as:
1. Disconnected operation for mobile computing;
2. High performance through client side persistent caching;
3. Server replication;
4. Security model for authentication, encryption and access control;
5. Continued operation during partial network failures in server network;
6. Network bandwidth adaptation;
7. Good scalability; and
8. Well defined semantics of sharing, even in the presence of network failures.

Also illustrated in FIG. 14 are the four primary hooks; conflict resolution, hoarding, data layout, and admin tools, used in connecting a client terminal to the system using the CODA file sharing system.

After the user has finished using the client terminal, the user can logout of the system by touching the logout link 96. The logout function disconnects the user from the system.

The basic concept, according to the present invention, is that everything that is personal to the user on a local computer, such as personal data and application settings is safe, and available from any computer terminal or networked device using an integrated computing system consisting of a client platform having local data storage and that automatically connects itself to a Remote Service Center 13 (FIG. 1).

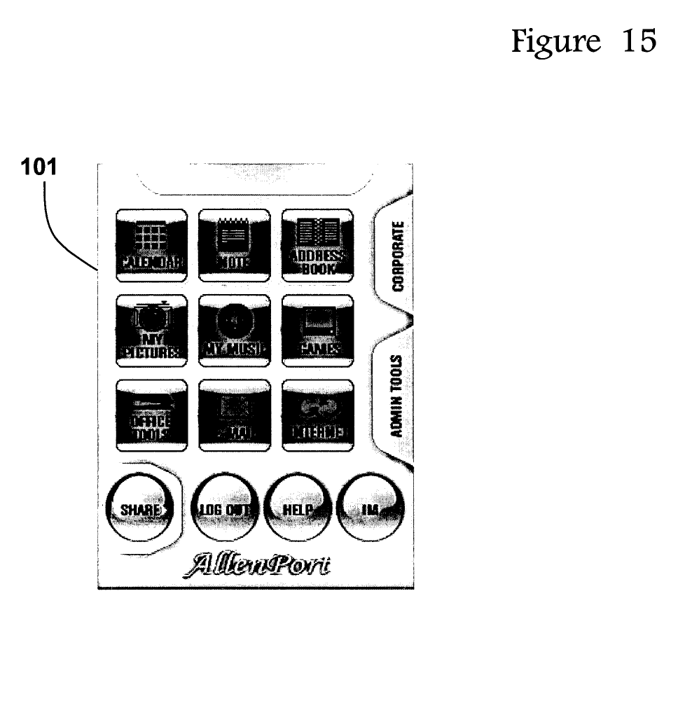

In another Embodiment, FIG. 15 shows a graphic user interface 101 as it may appear on a PDA device.

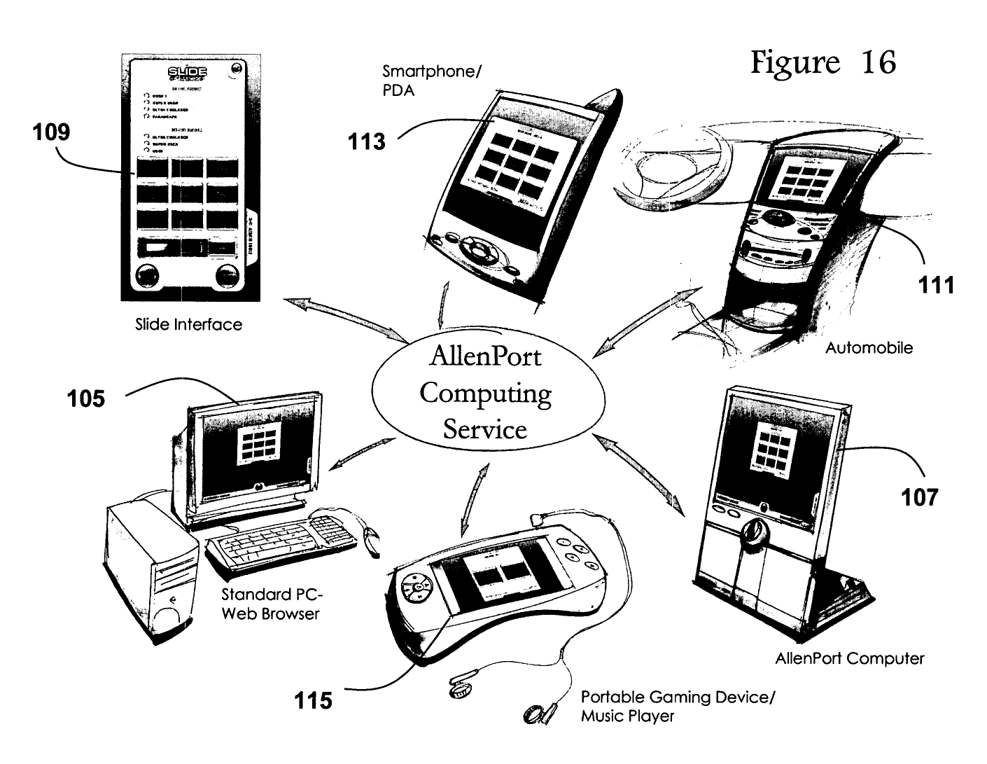

As shown in FIG. 16, the system can be installed on most PCs 105. It can be accessed on dedicated computer terminals 107 and through Slide interface 109. The system can be modified to fit on a small computing device like an automobile mounted smart screen 111, or a smart phone/PDA 113. In some embodiments, the system may include other applications with non-PC dependent devices, such as a network linked gaming device or music player 115.

Another embodiment of the system can be described in another scenario, by way of example: A photographer takes a photo using a digital camera that has a wireless network capability (802.11 for example). Once the photographer takes the picture, he may wish to print it to a stand-alone printer, without ever connecting to a PC, which can easily be done utilizing current technologies. However, assume the photographer has printed the pictures, and now wishes to save those images as part of his permanent archive.

The system described herein offers that functionality. If the camera has an authentication module, which would be made up of a biometric scanner, a network connection, and a small amount of processing capabilities, the photographer could login to the system using the camera as the client device. Using a biometric authentication device, the user can enter a PIN number, and be authenticated. The system would then connect the user to their Personal computing service. The user would then be able to upload the photo images to their Personai Computing Service and know that data is protected and managed. The same pictures would also be available on any other system-enabled device connected to the personal computing service. This same non-PC dependent device functionality can be implemented on music players, game machines, video machines, etc., as illustrated in FIG. 16.

The point is, personalized information and data is available anywhere there is an enabled device by which a user can log onto the system. Such device could be a desktop computer, a handheld device, a peripheral device, a car, and the like.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A method for packaging a user's personal computing environment on a client platform and mobilizing it for transfer over a network, said method comprising the steps of:
providing a remote server enabled for communication with the client platform;
storing the user's personal computer environment on said client platform and on said remote server;
enabling said user to log onto said client platform;
said client platform automatically connecting to said remote server; and
mirroring said user's computing environment on said client platform and said remote server.

2. The method according to claim 1, wherein said computing environment comprises:
(1) said user's personal data;
(2) said user's application settings; and
(3) software.

3. The method according to claim 2, wherein said software comprises open source software.

4. The method according to claim 2, wherein said software comprises a combination of open source software and proprietary software.

5. The method according to claim 1, said mirroring step further comprising:
incorporating a graphics system, a messaging system, and a distributed file sharing system to enable an interface between the user and selected application software and data.

6. The method according to claim 5, wherein said messaging system includes email, instant messaging, or file sharing.

7. The method according to claim 5, wherein said distributed file sharing system further comprises a plurality of hooks.

8. The method according to claim 7, said hooks being selected from the group consisting of:
conflict resolution;
administrative tools;
data layout; and
hoarding.

9. The method according to claim 1, said mirroring step further comprising:
simultaneously storing said user's personal data and application data on the local client platform and the remote server as such data may change during a user session.

10. The method according to claim 1, said mirroring step further comprising:
maintaining computer applications current using automatic updating that monitors the software and confirms, updates, and patches applications as needed by the user.

11. The method according to claim 1, said mirroring step further comprising:
managing authentication, local and remote caching of personalized data and software applications, and rights management of proprietary applications through a secure authentication and encryption system.

12. The method according to claim 1, wherein said step to enable said user to log onto said client platform further comprises:
displaying a login screen;
requiring said user to verify his or her identity;
validating said user as a subscribed customer; and
upon validation, displaying a personal desktop for said user.

13. The method according to claim 12, further comprising:
after requiring said user to verify his or her identity, requiring said user to input a personal identification number.

14. The method according to claim 12, wherein said step of requiring said user to verify his or her identity is performed by a biometric device.

15. The method according to claim 1, further comprising:
enabling remote control access of said client terminal over a secure network.

16. The method according to claim 16, wherein said remote access includes access to the user's applications and data.

17. The method according to claim 1, wherein said network comprises a secure network.

18. A system for packaging a user's personal computing environment on a client platform and mobilizing it for transfer over a network, said system comprising:
a remote server enabled for communication with the client platform;
a secure authentication and encryption system that enables said user to log onto said client platform and to automatically connect said client platform to said remote server; and
a software manager that monitors the user's personal computing environment and automatically mirrors said user's computing environment on said client platform and said remote server.

19. The system according to claim 18, wherein said software manager resides on said remote server.

20. The system according to claim 18, wherein said software manager simultaneously stores said user's personal data and application data on the local client platform and the remote server and updates such data as it may change during a user session.

21. The system according to claim 18, wherein said software manager maintains said user's computer applications current using automatic updating that monitors the software and confirms, updates, and patches applications as needed by the user.
